(19) United States
(12) Patent Application Publication
(10) Pub. No.: US 2011/0168431 A1
(43) Pub. Date: Jul. 14, 2011

(54) ELECTRIC CONDUCTOR AND METHOD FOR MANUFACTURING AN ELECTRIC CONDUCTOR

(75) Inventors: Stefan Schneweis, Graevenwiesbach (DE); Ralf Gaertner, Lahnau (DE)

(73) Assignee: Schunk Kohlenstofftechnik GmbH, Heuchelheim (DE)

(21) Appl. No.: 12/026,855

(22) Filed: Feb. 6, 2008

(30) Foreign Application Priority Data
Feb. 6, 2007 (DE) 10 2007 006 624.6

(51) Int. Cl. H01B 5/00; H01B 13/00

(52) U.S. Cl. 174/126.2; 29/825

(57) ABSTRACT

The invention relates to an electric conductor (21), in particular a heating conductor, having a supporting structure and an electrically conducting conductor material whereby the supporting structure is formed from a fiber composite (11) and the conductor material comprises a carbonaceous material (22) that adheres to the fiber composite.

### CROSS-REFERENCE TO RELATED APPLICATIONS

The present patent application claims priority from German Patent Application No. 10 2007 006 624.6, filed on Feb. 6, 2007.

### BACKGROUND OF THE INVENTION

The present invention relates to an electric conductor, in particular a heating conductor, having a supporting structure and an electrically conducting conductor material, such that the supporting structure is formed by a fiber composite and the conductor material comprises a carbonaceous material adhering to the fiber composite. In addition, the invention relates to a method for manufacturing an electric conductor, in particular a heating conductor, providing a supporting structure of a strand-shaped fiber composite, arranging the supporting structure according to a desired conductor geometry and securing the conductor geometry by means of a carbonaceous material applied to the fiber composite.

It has long been known that electric conductors, in particular heating conductors, which are arranged, e.g., in the form of an external coil that serves to heat surfaces or bodies such as line pipes, are made of metal. The use of metallic conductors or heating conductors in high-temperature areas, e.g., at temperatures >1000° C., however, often fails due to the inadequate thermal stability of metallic conductors. Therefore, there has been a trend toward manufacturing such conductors from a carbonaceous material based on a fiber composite designed as a semifinished product in flat or sheet form, from which the desired conductor arrangement can then be cut by suitable machining methods, e.g., milling.

However, the aforementioned method has proven to be very complex, in particular in the manufacture of three-dimensional conductor structures.

### SUMMARY OF THE INVENTION

Therefore, the object of the present invention is to propose an electric conductor and/or a method for manufacturing an electric conductor that will allow the creation of conductor structures and/or conductor arrangements even with complex three-dimensional structures in an especially simple manner.

This object is achieved by an electric conductor having the features of claim 1 and/or a method for manufacturing such a conductor having the features of claim 9.

According to the present invention, the electric conductor has a supporting structure and an electrically conducting conductor material, such that the supporting structure is formed by a fiber composite and the conductor material comprises a carbonaceous material adhering to the fiber composite.

The inventive structure of the electric conductor thus allows the conductor to be manufactured on the basis of a fiber composite, which serves as the supporting structure and is easily deformable and/or can be arranged easily with regard to the desired conductor geometry of the conductor. Since the conductor material comprises a carbonaceous material, it is not necessary for the fiber composite, which serves as the supporting structure, to have electrically conducting properties. Instead, the electric conductor properties may be assumed exclusively by the conductor material that adheres to the fiber composite.

Embodiments of the electric conductor in which the fiber composite of the supporting structure and/or the fibers forming the fiber composite are electrically conducting, such as carbon fibers, for example, are of course also possible.

However, the conductor material serves not only to implement the electric conducting function but also to stabilize and/or secure the fiber composite in the desired arrangement that determines the geometry of the finished conductor.

It is especially advantageous when the conducting material is made of carbon deposited pyrolytically on the fiber composite because the sublimate deposited from the vapor phase on the fiber composite ensures a uniform coating on the fiber composite.

If a deposit having a comparatively thin layer thickness is to be created on the fiber composite, then it is advantageous to provide a deposit created by using a CVI method (chemical vapor infiltration) on the fiber composite. Corresponding conductors which form a deposit on the fiber composite by a CVI method also have comparatively high penetration of the fiber composite by the carbon deposited from the vapor phase, so that such conductors have an increased strength, i.e., bending strength.

However, the inventive electric conductor may also have a conductor material comprising carbonized carbonaceous material so the inventive electric conductor can also be produced in an alternative production process, if needed. In this context, it is especially advantageous if the conductor material is formed from a glassy carbon, which can be created very easily by carbonizing a resin, in particular a phenolic resin, applied to the fiber composite by a known method.

Although, as already mentioned, the inventive conductor need not necessarily have a fiber composite with conducting properties as the supporting structure, it may prove advantageous, e.g., for adjusting a desired electric total resistance of the conductor, to manufacture the fiber composite from electrically conducting fibers, in particular carbon fibers.

In the case of an electric conductor which is provided with a carbon deposit by the vapor deposition method in particular, it may prove to be advantageous if the carbon coating is provided with another coating of silicon carbide which may be applied by a pyrolysis method, e.g., CVD. This creates an especially hard, dense surface, while on the other hand implementing a special oxidation protection due to the additional silicon carbide coating.

The inventive method for manufacturing an electric conductor, in particular a heating conductor, comprises the method steps of providing a supporting structure from a strand-shaped fiber composite, arranging the supporting structure according to the desired conductor geometry and securing the shape of the conductor geometry by means of a carbonaceous material applied to the fiber composite.

A preferred option for applying the carbonaceous material to the carrier structure comprises pyrolytic deposition of carbon on the fiber composite.

When carbon is deposited on the fiber composite by a CVD (chemical vapor deposition) method, an outer coating can be created on the fiber composite as a layer structure relatively rapidly to achieve the desired layer thickness.

When carbon is deposited by means of a CVI (chemical vapor infiltration) method on the fiber composite, it is possible to achieve a particularly high degree of penetration of the fiber composite with carbon, thus achieving a bonding of the individual fibers via the carbon such that it is mechanically load-bearing, resulting in a reinforcement of the fiber composite that is especially effective on the whole.

It is also possible to deposit carbon by means of a combination of a coating, in particular by means of CVD, with infiltration by means of CVI.

Another advantageous possibility for applying the carbonaceous material is to apply a carbonaceous substance, in particular an organic substance, to the fiber composite and then subsequently carbonize it. This makes it possible, for example, to manufacture a heating conductor having a coating of glassy carbon on the outside, in particular when a resin is used as the carbonaceous substance.

### BRIEF DESCRIPTION OF THE DRAWINGS

Different variants for performing the method and different embodiments of heating conductors are explained below with reference to the drawing.

In the drawings:

FIG. 1 shows a flow chart for manufacturing a heating conductor;

FIG. 2 shows a strand-shaped fiber composite for production of a supporting structure for a heating conductor;

FIG. 3 shows a heating conductor according to a first embodiment in an overall diagram;

FIG. 4 shows a cross-sectional diagram of the heating conductor illustrated in FIG. 3; and

FIG. 5 shows a cross-sectional diagram of an alternative heating conductor.

### DETAILED DESCRIPTION OF THE INVENTION

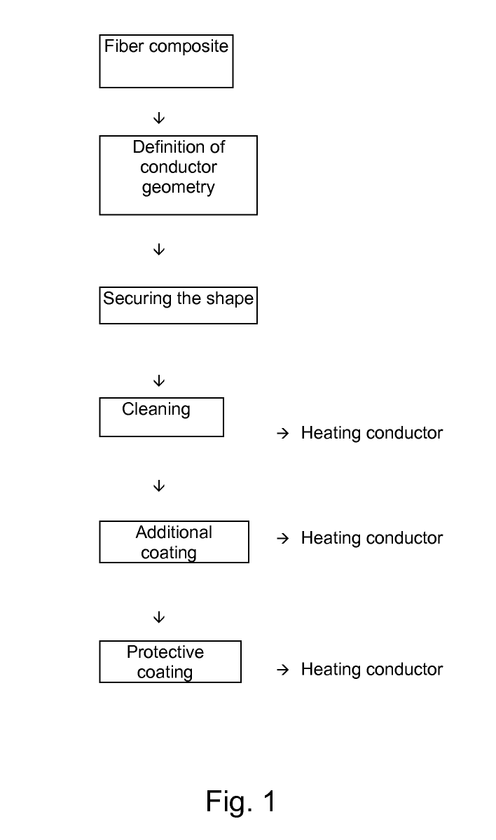

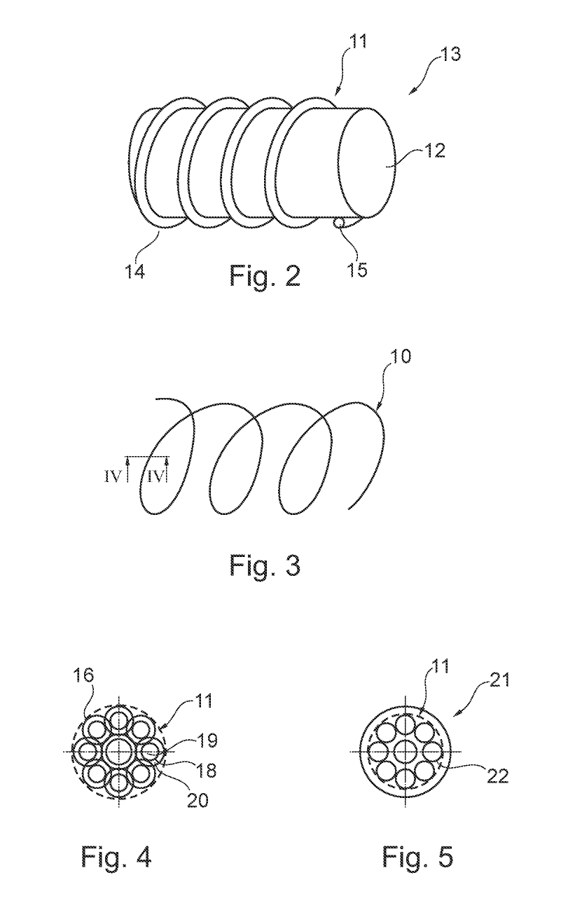

The flow chart shown in FIG. 1 for the manufacture of a heating conductor 10 (FIG. 3) illustrates the manufacture of the heating conductor 10 based on a fiber composite 11 designed in the form of a strand-shaped fiber composite 11, which is illustrated in FIG. 2 and is arranged on a molded body 12 to define a three-dimensional arrangement or conductor geometry 13. The molded body 12, designed here as a cylindrical graphite body, serves to define the spiral-shaped conductor geometry 13 in the present case.

The strand-shaped fiber composite 11 in the present case comprises a braided tube made of carbon fibers, the wall of the tube being designed like a flexible cable. In carbon fiber technology, such braided tubes are used as standard semifinished products. In deviation from the preceding exemplary embodiment, however, it is equally possible to use a fiber composite as the starting basis for manufacturing the heating conductor 10, which is made of nonconducting fibers, e.g., aluminum oxide.

The conductor geometry 13 shown in FIG. 2, designed according to the circumference of the molded body 12, can easily be arranged on the molded body 12, e.g., by securing only the ends 14, 15 of the fiber composite 11. To secure the shape of the fiber composite arrangement, i.e., the conductor geometry 13 according to the given arrangement on the molded body 12, carbon is now deposited from the vapor phase on the fiber composite 11 while the fiber composite 11 is being arranged on the molded body 12 according to a preferred variant of the method.

The carbon is preferably deposited from a methane phase in vacuo under conditions that allow so-called “chemical gas-phase infiltration” (chemical vapor infiltration, CVI) during the course of which the carbon not only sublimes from the vapor phase onto the surface of the fiber composite but instead penetrates through the fiber composite and ensures bonding of the fibers 19 to one another in the fiber composite 11, as illustrated in FIG. 4, for example. Due to the infiltration of carbon into the fiber composite, the carbon deposit 16 is formed not only on an outside circumference 17 of the fiber composite 11 but also on the circumferential surfaces 18 of the individual fibers. This results in formation of a bridge 20 between the fibers 19 with a strong reinforcing effect on the fiber composite 11.

For the carbon deposit 16 produced by the aforementioned CVI method, different layer thicknesses, including a layer thickness of <20 μm have been achieved in experiments.

Depending on the desired intended purpose of the heating conductor 10, the end product can already be achieved after securing the shape by the CVI method as mentioned above.

Especially in the case when a greater layer thickness of the pyrolysis layer is to be achieved to further increase the electric conductivity of the conductor, for example, a second carbon deposit may optionally be created on top of the first carbon deposit 16 after a vapor phase cleansing. The CVD method is preferably used because the fiber composite 11 has already been permeated with carbon by the CVI method and therefore accelerated creation of the layer can be achieved in producing the second carbon sublimate.

Regardless of whether only one carbon sublimate is produced on the fiber composite 11 by the CVD method or the CVI method, it may prove advantageous to apply a protective silicon carbide layer to the carbon sublimate in a subsequent pyrolysis process.

Alternatively or additionally, it is also possible to provide different layers, e.g., layers having TiC, TiN, Al₂O₃, ZrO₂ or combinations thereof, for example. These layers can be applied by the respective suitable methods, e.g., PVD, immersion in free-flowing, fluid or pasty coating materials, plasma sputtering, etc.

In particular when the demands made regarding the stiffness of the heating conductor are not so high, it is also possible to create a carbon sublimate 21 on the fiber composite 11 by the CVD (chemical vapor deposition) method to produce a heating conductor 21 as illustrated in FIG. 5 by securing the shape of the fiber composite 11, such that the carbon sublimate is arranged essentially on the outer circumference 17 of the fiber composite 11, as shown in particular by a comparison of FIGS. 4 and 5, without the formation of a bridge 20, such as the cross section of the heating conductor 10 shown in FIG. 4.

Experiments have shown that the layer thickness of the carbon sublimate 21 produced by the aforementioned CVD method should be in the range between 5 μm and 100 μm.

Regardless of which of the aforementioned methods of vapor deposition of carbon on the fiber composite is selected or whether the formation of a carbonaceous electrically conductive conductor material that secures the shape on the fiber composite by carbonization is preferred, all the variants of the method for producing a flexurally rigid heating conductor based on a flexurally slack fiber composite that can be arranged in any spatial geometries result in a flexurally rigid heating conductor having a small cross-sectional diameter. This heating conductor opens up previously unknown design possibilities with miniaturization at the same time. Furthermore, heating conductors produced in this way can be used at temperatures up to 3000° C. Furthermore, it may be used not only as a heating conductor but also in the field of sensor technology, e.g., as a measurement conductor at high ambient temperatures.

What is claimed:

1. An electric conductor (10, 21), in particular a heating conductor, having a supporting structure and an electrically conducting conductor material, such that the supporting structure is formed from a fiber composite (11) and the conductor material comprises a carbonaceous material (16, 22) that adheres to the fiber composite.

2. The electric conductor according to claim 1,
characterized in that
the conductor material comprises carbon (16, 22) deposited pyrolytically on the fiber composite (11).

3. The electric conductor according to claim 2,
characterized in that
the carbon is formed as a deposit (22) on the fiber composite (11) produced by a CVD method.

4. The electric conductor according to claim 2,
characterized in that
the carbon is formed as a deposit (16) on the fiber composite created by a CVI method.

5. The electric conductor according to claim 1,
characterized in that
the conductor material comprises carbonized carbonaceous material.

6. The electric conductor according to claim 5,
characterized in that
the conductor material is formed from glassy carbon.

7. The electric conductor according to claim 1,
characterized in that
the fiber composite (11) comprises carbon fibers (19).

8. The electric conductor according to claim 1,
characterized in that
the conductor material is provided with a coating of silicon carbide.

9. A method for manufacturing an electric conductor (10, 21), in particular a heating conductor, comprising:
providing a supporting structure of a strand-shaped fiber composite (11),
arranging the supporting structure according to a desired conductor geometry (13) and
securing the shape of the conductor geometry by means of a carbonaceous material (16, 22) applied to the fiber composite.

10. The method according to claim 9,
characterized in that
carbon (16) is deposited pyrolytically on the fiber composite (11) to apply the carbonaceous material.

11. The method according to claim 10,
characterized in that
the carbon (22) is deposited on the fiber composite (11) by means of a CVD method.

12. The method according to claim 10,
characterized in that
the carbon (16) is deposited on the fiber composite (11) by means of a CVI method.

13. The method according to claim 9,
characterized in that
a carbonaceous substance, in particular an organic carbonaceous substance is applied to the fiber composite and carbonized to apply the carbonaceous material.

14. The method according to claim 13,
characterized in that
a resin is used as the carbonaceous substance.
